(19) United States
(12) Patent Application Publication
(10) Pub. No.: US 2003/0009364 A1
(43) Pub. Date: Jan. 9, 2003

(54) Facility management system based on flow-line information

(76) Inventors: Masanori Miyoshi, Mito (JP); Hiroshi Shojima, Hitachiota (JP); Yoshiaki Usami, Hitachi (JP); Kazuya Takahashi, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/184,935

(22) Filed: Jul. 1, 2002

Related U.S. Application Data
(63) Continuation of application No. 10/040,453, filed on Jan. 9, 2002.

(30) Foreign Application Priority Data
Jul. 6, 2001 (JP) 2001-206405

(51) Int. Cl. G06F 17/60

(52) U.S. Cl. 705/7

(57) ABSTRACT

Since it is not possible to automatically determine the appropriateness of a layout at present, there has been a problem in that it is impossible to change the layout of the facility at an appropriate timing. To solve this problem, the appropriateness a facility is judged based on a movement cost calculated using an automatically measured flow line of a moving body. In order to attain such a result, flow line-measuring is carried out for measuring the flow line of a moving body by detecting the moving body as an object to be monitored; movement cost-calculating is carried out for calculating a cost expended on movement of the moving body derived from low line information; and movement cost-evaluating is carried out for judging whether or not a cost calculated by the movement cost-calculating process is within a permissible range.

The present application is a continuation of application Ser. No. 10/040,453, filed Jan. 9, 2002, the contents of which are incorporated herein by reference.

### BACKGROUND OF THE INVENTION

The present invention relates to a facility management system for effectively using a facility based on information derived from measurement of person flow lines.

In order to more effectively use a facility, such as an office building or a manufacturing line in a factory, for example, various kinds of facility management technologies are being developed.

Among them, there are technologies directed toward achieving more effective use of a facility by optimizing the layout of the facility. In regard to a technology whose purpose is to optimize the layout of an office building, a technique known as zoning is described in “Facility Management Guidebook; second edition” (Nikkan Kougyou Shinnbun Co.) p. 356 to p. 359. Zoning is a technique for laying out departments in spaces inside a building so that a company or organization may more effectively function in their spaces. In order to do so, the degree of proximity representing the extent of relationship between departments is researched, and the departments having a high degree of proximity in their relationship with each other are laid out in spaces as close to one another as possible. Therein, it can be considered that, as the degree of proximity between departments is higher, movement will more frequently occur between the departments. Therefore, by means of the layout described above, it is possible to totally reduce the time expended on movement which produces any value, and, accordingly, it is possible to attain more effective use of the office building.

Further, in regard to technologies that are directed toward optimization of a layout of a manufacturing line in a factory, a method of configuring a semiconductor manufacturing line is disclosed in Japanese Patent Application Laid-Open No.6-84740. In this technology, the manufacturing line is laid out so that the distances through which persons and materials move may be shortened under a constraint that the amount of equipment is reduced as much as possible. By doing so, it is possible to reduce the time expended in movement, and, accordingly, it is possible to attain more effective use of the manufacturing line.

Furthermore, there are technologies for imposing a usage charge corresponding to the degree of use of a facility in order to reduce the maintenance and management costs of a commonly used facility, or to reduce a feeling of guilt in the unfair sharing of maintenance and management costs among users. For example, Japanese Patent Application Laid-Open No.6-187348 discloses a method wherein, under the assumption that a shopping building uses a common parking lot, a bad feeling among the shops is eliminated by determining each shop's proper share of the cost of customer parking fares based on the sales volume of each shop relative to the customers use of the common parking lot. Therein, when a customer leaves the parking lot, a construction ratio of sales for each shop is calculated with reference to POS (Point Of Sale; a point-of-sale information management system) information so as to calculate a share of the parking charges for each shop based on the construction ratio. Thereby, it is possible to impose a realistic charge on each shop without creating a bad feeling among the shop owners.

Still further, there is a technology for automatically controlling a facility, such as an elevator installed in a building, according to movements of persons that are undertaken at the convenience of the persons. For example, Japanese Patent Application Laid-Open No.2000-191246 discloses a technology in which the calling of an elevator is eliminated and the waiting time for the elevator is shortened. Therein, the object to be controlled relates to an elevator installed in an apartment house, and the elevator is automatically called by anticipating that, when doors at the common entrance and at each apartment or unit are opened or closed, there is high probability of someone taking the elevator. By doing so, the operation of calling the elevator becomes unnecessary because the elevator is automatically called by detecting the opening and closing of doors to the building or apartments therein. In addition, since the elevator can be called from a place distant from the elevator, the waiting time at the elevator can be shortened.

Further, maintenance work for a facility, such as cleaning, is generally performed periodically after establishing a maintenance plan. For example, it can be assumed that cleaning is performed every Monday and Thursday.

Furthermore, Japanese Patent Application Laid-Open No.2000-191246 discloses a person flow line information collecting method and a person flow line information collecting system in which a plurality of picture-taking means are individually installed at a plurality of positions inside a facility, including at an entrance, and individual person flow line information as a function of time is collected by extracting a personal image from captured images. In the personal flow line information, personal attribute information and flow line information are correlated to each other, and, accordingly, a store-visiting pattern on a attribute basis can be automatically collected. Further, Japanese Patent Application Laid-Open No.11-64505 discloses a flow line searching system for calculating and displaying a path of movement of a customer by installing transmitters at various positions inside a shop and attaching a receiver to a shopping basket. Since the path of movement of a person inside a facility can be certainly determined by the system, the layout inside the facility can be easily changed to a more efficient layout.

Even if a layout of a facility is appropriate in the beginning, the layout may gradually become inappropriate with the passage of time due to a change in the conditions under which the facility is used, which may be caused by changes in the organization or the like. Therefore, it is important to change the layout of the facility at an appropriate time by determining the appropriateness of the layout at the present time. However, the conventional technologies in regard to zoning as described above require a large amount of manpower, because the present status of the layout needs to be manually evaluated. Therefore, it is difficult to evaluate the appropriateness of a layout continuously, and, accordingly, there has been a problem in that it is difficult to determine an appropriate timing for effecting a change in the layout.

Further, the above-described conventional technology in regard to the layout of a manufacturing line in a factory, as disclosed in Japanese Patent Application Laid-Open No. 6-84740, is a technology used in a layout planning stage, and, accordingly, modification after completion of the layout has not been considered in connection with this technology. Therefore, the status of a layout after completion of the layout can not be determined, and, accordingly, there has been a problem in that it is impossible to change the layout of the facility at an appropriate timing.

Further, the above-mentioned conventional technology in regard to the imposing of a parking charge, as disclosed in Japanese Patent Application Laid-Open No.6-187348, is formed on the premise that POS information is used, so that there is a problem in that the technology can not be applied to a case where use of the POS information is impractical, such as in the case of an office building.

Further, in the above-mentioned conventional technology in regard to the automatic calling of an elevator, as disclosed in Japanese Patent Application Laid-Open No.2000-191246, the calling of the elevator is based only on a single event, such as the of opening and closing of a door. Therefore, there is a problem in that application of the technology is limited only to an apartment house in which the residents have high probability of following a pattern of opening a door and then taking the elevator.

Further, the above-mentioned conventional technology in regard to performing maintenance work in a facility has the following problem because the maintenance work is periodically performed regardless of the status of use of the facility, such as the number of users. The problem is, for example, that even if maintenance is necessary, the maintenance is not performed, thereby to cause problems with respect to the appearance or safety of the facility, or, on the other hand, even if maintenance is unnecessary, the maintenance may be performed, thereby to cause unnecessary cost.

Further, the methods of automatically collecting person flow line information as disclosed in Japanese Patent Application Laid-Open No. 2000-191246 and Japanese Patent Application Laid-Open No.11-64505 are difficult to carry out for detailed flow line information including specific attributions of a moving body, because an unspecified number of persons are objects to be monitored, and, accordingly, the usable form of the information is limited to a special use, such as modification of the layout in a facility.

### SUMMARY OF THE INVENTION

An object of the present invention is to provide a facility monitoring system which monitors identified persons, that is, identified persons having a strong connection with a facility having objects to be monitored, such as the employees or the residents of the facility, and which can provide very useful movement cost information.

Another object of the present invention is to provide a facility monitoring system having a movement cost monitoring function which monitors a condition of appropriateness of the layout at present through collection of flow line information of identified persons having a strong connection with a facility, and which can recommend to a user the need for a change in the layout at an appropriate timing.

A further object of the present invention is to provide a facility maintenance assisting system for planning appropriate maintenance work at a facility corresponding to a use status in the facility.

In order to attain the above objects, the present invention is characterized by a facility management system comprising a flow line-measuring means for measuring a flow line of a moving body by detecting the moving body in a facility to be monitored; and a management information generating means for producing management information for management from the flow line information, wherein the management information generating means comprises a moving body identifying means for identifying the moving body; and a movement cost-calculating means for calculating a cost expended on movement of the moving body from the flow line information, wherein the movement cost-calculating means calculates the movement cost based on a time unit price specific to the identified moving body and a time period required for the movement as the movement cost.

Further, in order to attain the above objects, the present invention comprises a flow line-measuring means for detecting a moving body in a facility to be monitored, and for measuring a flow line of the moving body; a facility-using status-calculating means for identifying a user from the measured flow line data and facility data of information specific to a facility, such as the location of the facility, the maintenance management cost and so on, and for calculating facility-using status data of information relating to use of the facility, such as the period of use and so on; an imposed charge-calculating means for calculating imposed charge data showing a relationship between an amount of imposed money and a department to be imposed on from the calculated facility-using status data, the facility data and organization data expressing a relationship between said user and the department in the facility; and an accounting processing means for totally performing accounting processing based on the imposed charge data.

Further, in order to attain the above objects, the present invention comprises a flow line-measuring means for detecting a moving body in a monitored object and for measuring a flow line of the moving body; a flow line history-checking means for judging whether or not the measured flow line data conforms with a flow line history pattern expressing a condition of calling an elevator, and for calling the elevator when the measured flow line information conforms with the flow line history pattern; and an elevator-control means for actually controlling the elevator.

Further, in order to attain the above objects, the present invention comprises a flow line-measuring means for detecting a moving body in a monitored object, and then measuring a flow line of the detected object; a histogram-calculating means for dividing a facility into small zones based on the flow line data, and then calculating histogram data expressing a frequency of use for each of the small zones; a histogram-evaluating means for forming a maintenance plan corresponding to the frequency of use obtained from the calculated histogram; and a facility maintenance planning means for integrating the whole maintenance plan based on the individual maintenance plans.

### BRIEF DESCRIPTION OF DRAWINGS

FIG. 1 is a block diagram showing the functional structure of an embodiment of a facility management system, including a movement cost monitoring system, in accordance with the present invention.

FIG. 2 is a block diagram showing the hardware structure of the movement cost monitoring system in accordance with the present invention.

FIGS. 3(a) and 3(b) are is flowcharts showing the flow of the total processing of the movement cost monitoring system in accordance with the present invention.

FIG. 4 is a diagram illustrating an example of a flow line measuring unit using video cameras.

FIG. 5 is a diagram illustrating an example of flow line data obtained by the video cameras.

FIG. 6 is a table showing an example of a data structure of the flow line data obtained by the video cameras.

FIG. 7 is a flowchart showing a flow of movement cost calculation processing.

FIG. 8 is a flowchart showing a flow of flow line length calculation processing.

FIG. 9 is a diagram showing an example of an output display.

FIG. 10 is a block diagram showing the functional structure of a movement cost monitoring system having a facility layout optimization means.

FIG. 11 is a diagram showing an example of calculation of cost corresponding to movement.

FIG. 12 is a block diagram showing the functional structure of a facility using a charge imposing system for an office building.

FIG. 13 is a block diagram showing the functional structure of a facility using a charge imposing system for a shopping building.

FIG. 14 is a block diagram showing the functional structure of an elevator automatic calling system based on a flow line history.

FIG. 15 is a diagram showing an example of facility control based on a flow line history.

FIG. 16 is a diagram showing an example of flow line history checking.

FIG. 17 is a block diagram showing the functional structure of a facility maintenance assisting system.

FIG. 18 is a diagram showing an example of a flow line histogram.

FIG. 19 is a diagram showing an example of a person flow measuring system using PHS.

FIG. 20 is a table showing an example of a data structure of flow line data obtained by the PHS.

FIG. 21 is a table showing an example of facility-using status data.

FIG. 22 is a flowchart showing a flow of imposed charge calculation processing.

FIG. 23 is a table showing an example of flow line histogram evaluation.

FIG. 24 is a diagram illustrating an example of the frequency of movement between small zones.

FIG. 25 is a table showing an example of degree of relationship between facilities.

FIG. 26 is a diagram showing another embodiment of a business form in accordance with the present invention in a case where movement costs produced at store A and store B are remotely monitored by a monitoring center.

FIG. 27 is a block diagram showing an example of a detailed functional structure for applying the movement cost monitoring system in accordance with the present invention to the business form of FIG. 26.

### DESCRIPTION OF THE PREFERRED EMBODIMENTS

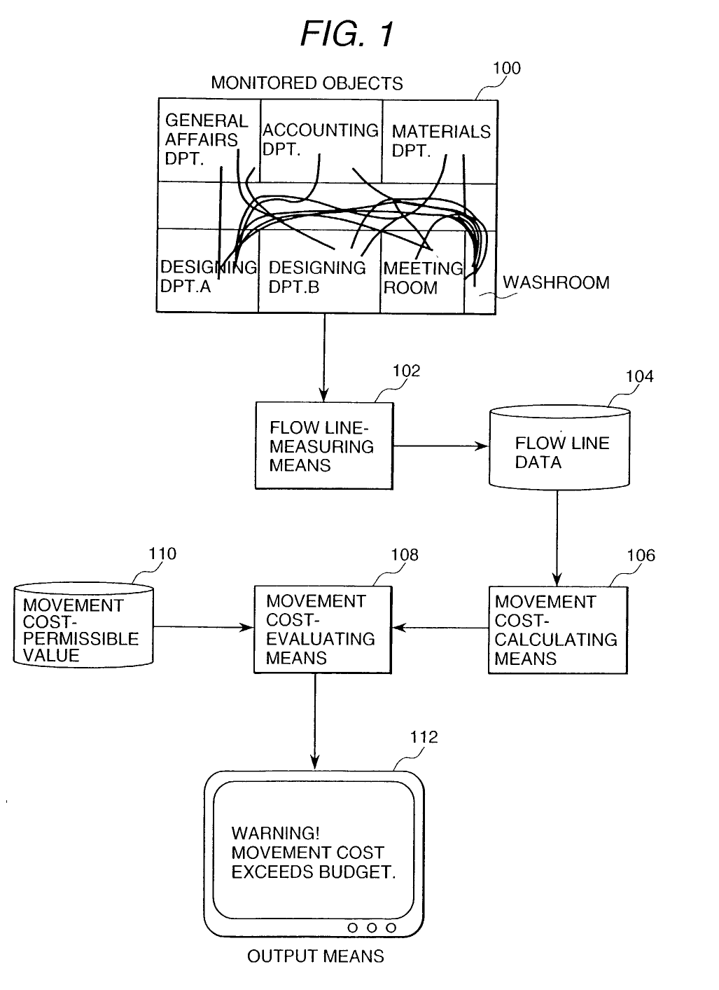

Embodiments of the present invention will be described below in detail with reference to the accompanying drawings. FIG. 1 shows the functional structure of a facility management system including a movement cost monitoring system in accordance with the present invention. A monitored object 100 is a zone of the real world to be monitored by the present system, and a moving body, such as a person existing in the zone, is an object to be monitored. The facility management system comprises: a flow line-measuring means 102 for detecting a moving body in the zone 100 of the facility and for measuring a flow line or path of the moving body; and a management information generating means for generating management information for management based on the flow line information. The management information generating means comprises: a moving body identifying means for identifying the moving body; a movement cost-calculating means 106 for calculating the cost expended on the movement of the moving body 100 based on the flow line information; a movement cost-evaluating means 108 for evaluating the calculated cost according to a given standard; a control means for generating a display, providing a warning and effecting control based on the movement cost evaluation result; a facility layout-optimizing means; and an output means 112.

As will be described later, the moving body identifying means specifies a person as the moving body through a method of checking features in a picture of the moving body taken by a video camera and which is processed with pre-stored data or using IC card data or using a PHS terminal.

The flow line-measuring means 102 detects the moving body in the monitored object 100, measures the flow line or path of the moving body, and accumulates the result as flow line data 104. The movement cost-calculating means 106 calculates the cost expended on movement of the moving body. That is, a movement cost is determined from the accumulated flow line data 104. As the movement cost, the total movement time of the moving body, the total movement distance of the moving body or the like may be considered. The movement cost-evaluating means 108 compares the movement cost calculated by the movement cost-calculating means 106 with a movement cost-permissible value 110 preset by a user of the present system, and judges whether or not the movement cost is within the permissible range. The output means 112 is a display unit, such as a video monitor, which outputs an image or voice in order to cause the user of the present system to pay attention when it is judged that the movement cost at present exceeds the permissible range.

Here, the value of the movement cost calculated by the movement cost-calculating means 106 may be directly output using the output means 112, instead of outputting the evaluated result of the movement cost-evaluating means 108 using the output means 112.

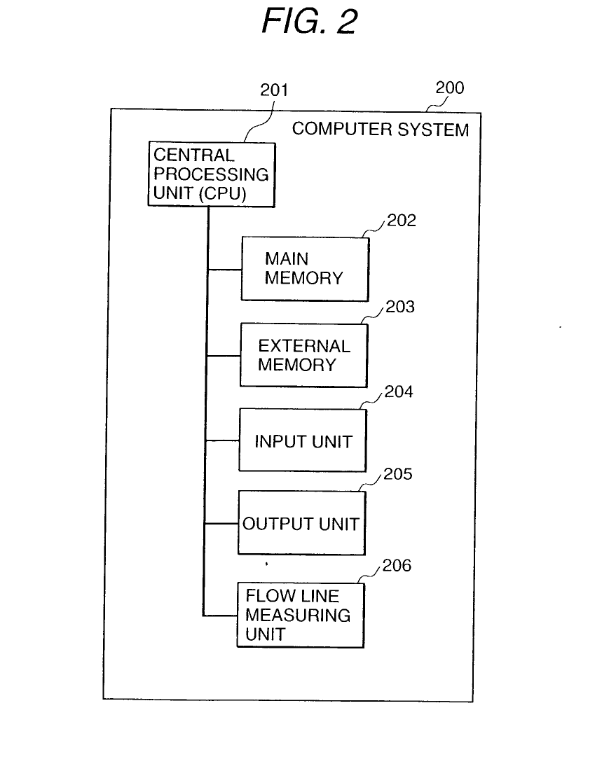

FIG. 2 shows the hardware structure of the movement cost monitoring system in accordance with the present invention. The movement cost monitoring system of the present invention is formed by a computer system 200. The computer system 200 consists of a central processing unit (CPU) 201, a main memory 202, an external memory 203, an input unit 204, an output unit 205, a flow line measuring unit 206 and a bus 207. The central processing unit 201 is a unit for controlling the whole computer system 200. Here, the central processing unit provides the function of the movement cost monitoring system in accordance with the present invention based on programs realizing the functions of the flow line-measuring means 102 stored in the main memory 202, the movement cost-calculating means 106 and the like. The main memory 202 is a memory capable of accessing data at a high speed, such as a RAM (random access memory), and is capable of temporarily storing a control program and data for use by the central processing unit 201. The programs etc. for realizing the function of the flow line-measuring means 102, the movement cost-calculating means 106, etc., are read from the external memory 203 and stored in the main memory. The data, such as the flow line data 104 necessary for executing these programs, may be read from the external memory 203 and stored in the main memory 202, if necessary.

The external memory 203 is a unit such as magnetic disk unit, which is slow in data access, but large in memory capacity compared to the main memory 202, and it semi-permanently stores the control program and the data for the central processing unit 201. The programs etc. for realizing the function of the flow line-measuring means 102, the movement cost-calculating means 106 etc. and the data etc., such as flow line data 104 necessary for executing these programs, are stored in the external memory 203. The input unit 204 is a unit consisting of a keyboard, a mouse and the like, which through which operation of the system by the user of the present system is effected. The output unit 205 is a unit for displaying a monitored result in the form of an image, such as a CRT (cathode ray tube) display, a liquid crystal display or the like, or a unit, such as a speaker for indicating the analysis result in a form of sound, such as a warning sound. The output unit 205 represents the output means 112.

The flow line measuring unit 206 is a unit consisting of a wireless unit, an IC card and a video camera, and this flow line measuring unit 206 represents the flow line-measuring means 102. The measured flow line data 104 is stored in the main memory 202 or the external memory 203. These units are connected to one another by the bus 207 for exchanging data at high speed between the units. As the bus 207, a network, such as Ethernet, having a data transmission speed that is not so high, or other connecting means may be used.

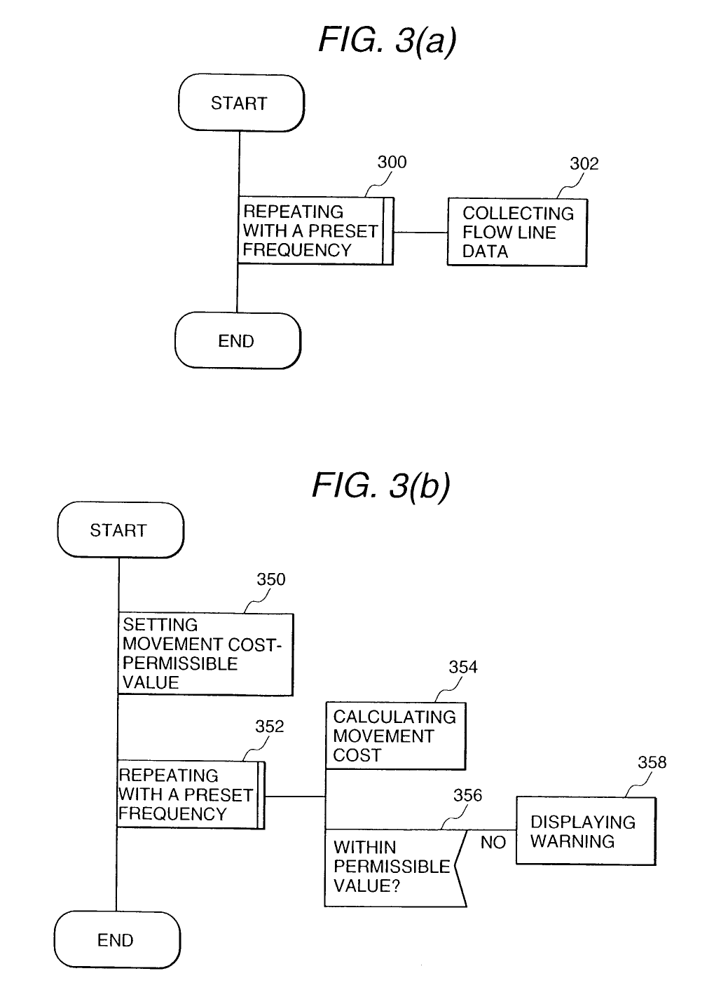

The flow of the total process of the movement cost monitoring system of FIG. 1 in accordance with the present invention will be described with reference to the flowcharts shown in FIGS. 3(a) and 3(b). The total process can be roughly divided into two portions. One is a process of collecting the flow line data, and the other is a process of evaluating the flow line data. These two processes, which are asynchronously processed in parallel, will be successively described below.

Initially, the process of collecting the flow line data, which is shown by FIG. 3(a), will be described. This is a process for obtaining the flow line of a moving body in the monitored object 100. In Step 300, the process of Step 302 is repeated with a given frequency. The given frequency is, for example, a frequency of once per second. In Step 302, the position of a moving body is measured using the flow line-measuring means 102. By the processes of Step 300 to Step 302 described above, a group of points approximately expressing the flow line of the moving body can be obtained. The result is stored as the flow line data 104.

Next, the process of evaluating the flow line data, as shown in FIG. 3(b), will be described. This is a process for evaluating the flow line data 104 obtained by the measurement. In Step 350, the user of the present system sets a movement cost-permissible value 110. In Step 352, the processes of Step 354 to 358 are repeated with a given frequency. The given frequency is, for example, a frequency of once per month. In Step 354, a movement cost expended on movement of the moving body is calculated using the flow line data for the given time period. In Step 356, it is judged whether or not the calculated movement cost is within the range of the set cost-permissible value. In more detail, when the calculated movement cost becomes larger than the cost-permissible value 110, it is judged that the calculated movement cost exceeds the cost-permissible value. In Step 358, when it is judged in Step 356 that the movement cost exceeds the cost-permissible value, a warning is output to the user of the present system using the output means 112.

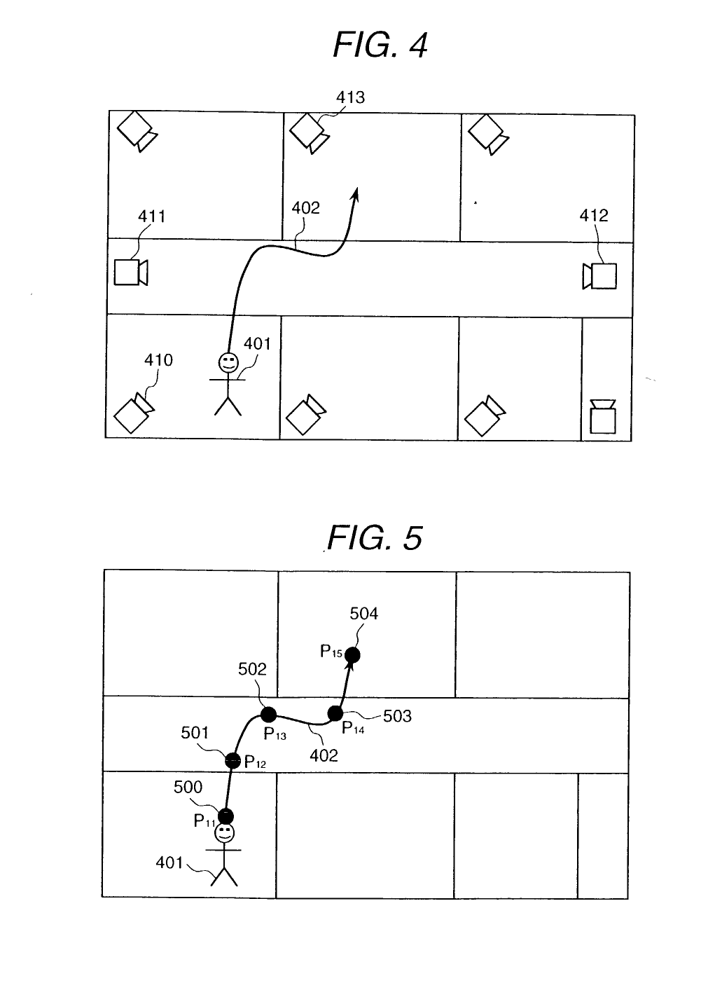

An example of a system using video cameras as the flow line measuring unit 206 will be described. Initially, a plurality of video cameras are installed in a building so as to produce as few places that are incapable of being viewed by the video cameras, that is, blind spots, as possible. By interconnecting the plurality of video cameras, a person moving in the zone is traced through image processing to detect the flow line. For example, as seen in FIG. 4, when the person 401 moves along the flow line 402, the person 401 is traced on the picture by interconnecting the video camera 410, the video camera 411, the video camera 412 and the video camera 413 detect a picture of the person 401. Therefore, by establishing a condition such that the actual position of the body in the building can be identified from the position of the body on the picture taken by the cameras, the flow line 402 can be obtained from the picture image.

In a case of using image processing, it is generally difficult to identify a person or a moving means among an unspecified number of persons or moving means taken by the video cameras. However, in the case where the persons or the moving means to be identified are limited to the persons having a close connection to the facility of the monitored object, a person can be identified by producing specific vectors from images of the persons, and by checking a person with attribute information or the specific vector of each of the persons in a list of monitored persons. In other words, features on the picture of persons to be identified are pre-stored in a database, and a feature on a picture of a person taken at the time of measuring a flow line is compared with the features in the database, and then the person in a picture taken at the time of measuring a flow line can be identified as a specific person in the database whose feature most agrees with the feature on the picture.

An example of a flow line 104 measured by the flow line-measuring means 102 will be explained with reference to FIG. 5. Since the flow line-measuring means 102 continuously detects positions of a moving body at a given time interval, a plurality of continuous points on a flow line are measured when a person moves along the flow line. For example, when the person 401 moves along the flow line 402, the person 401 is detected at a train of points, that is, the point 500, the point 501, the point 502, the point 503 and the point 504. Here, the flow line is approximately expressed by the train of plural points. In order to improve the approximation accuracy, the measurement interval of the flow line-measuring means 102 should be small, or the generally used method of expressing a free curve, such as the spline interpolation, should be employed.

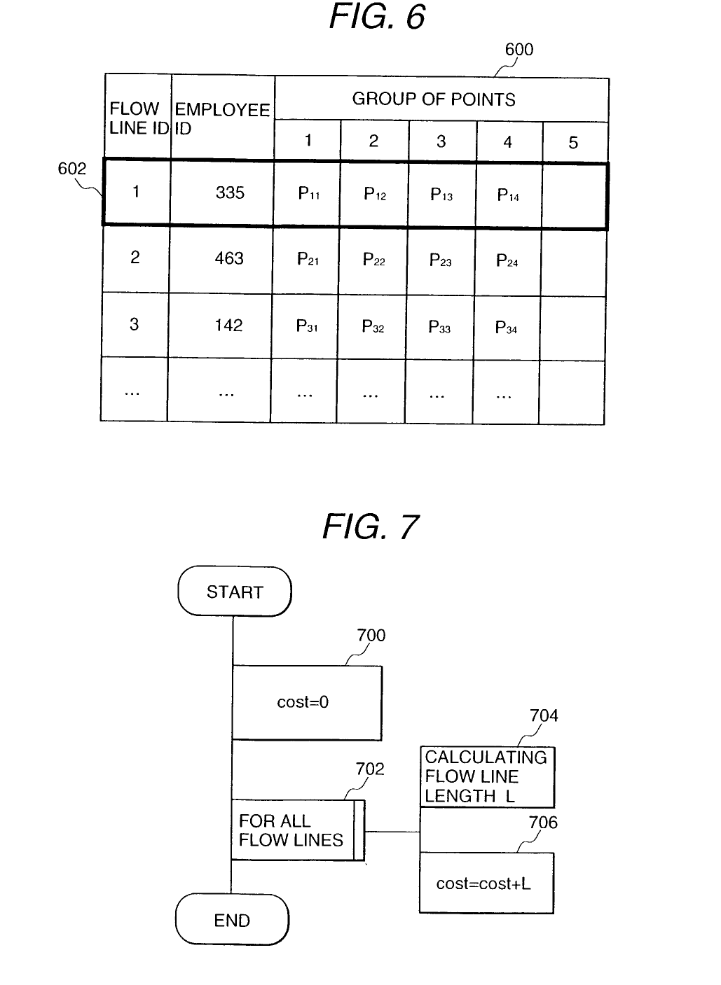

An example of a data structure, in a case where the flow line data is handled using a computer, will be described with reference to FIG. 6. The table 600 is a table for storing data associated with a plurality of flow lines measured by the flow line-measuring means 102. Measured data for one flow line is stored in each row, that is, each record of the table. The record 602 represents an example of stored flow line data for the flow line 402. The record includes a flow line ID in the form of a unique number for identifying measured flow line data, an employee ID in the form of a unique number identifying a person to be measured, and point train information for a group of points on the flow line. However, it is not always necessary to store all the information described above. Information not used for processes to be executed later may need not be stored. On the contrary, information in connection with a flow line, such as the time of measuring the point train, other than the above information may be stored, depending on necessity.

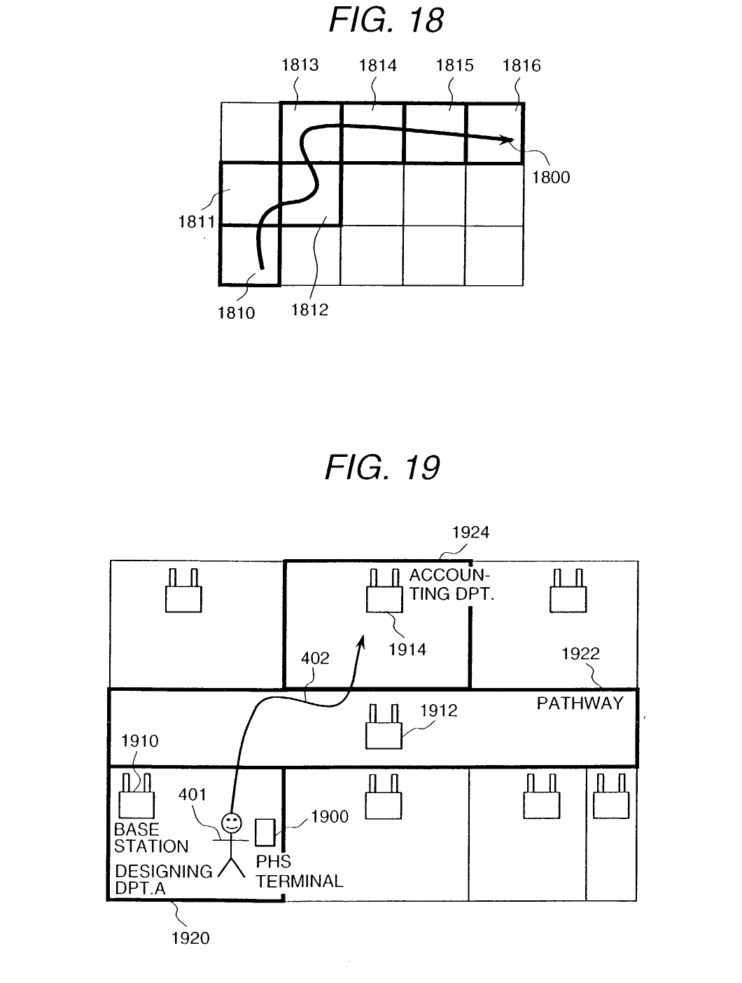

Another example of the flow line measuring unit 206 will be described with reference to FIG. 19. This is a method using a PHS (personal handyphone system), which is one form of cordless telephone system. The PHS is a system which makes it possible to carry on voice communication by communicating between a PHS terminal carried with a person and a plurality of base stations located inside a building. The PHS terminal can detect the intensity of an electric field applied by each of the base stations. In general, since the intensity of electric field becomes stronger as the distance between the PHS terminal and the base station is shorter, it can be determined that the PHS terminal exists at a place nearest a base station which gives the strongest intensity of electric field to the PHS terminal. Here, since the base stations are fixed inside the building, their location can be known in advance, and, accordingly, the position of the PHS terminal can be roughly identified relative thereto.

By using this mechanism, a flow line of a person having a PHS terminal can be determined by successively detecting the positions of the PHS terminal. Further, since each of the PHS terminals has a specific identifier, each PHS terminal can be individually identified. Therefore, by forming a database of persons having PHS terminals in advance, a person having a PHS terminal can be identified.

FIG. 19 shows an example of measuring a flow line using a PHS when a person 401 having the PHS terminal 1900 moves along the flow line 402. When the person 401 having the PHS terminal 1900 is in a room the Design Department A 1920, it can be recognized that the person 401 is at a place near the base station 1910 because the electric field received from the base station 1910 installed in the same room is considered to be the strongest. Similarly, when the person 401 is in a passageway 1922 or in a room of the Accounting Department 1924, it can be recognized that the person is at a position near a base station 1912 or a base station 1914, respectively. Therefore, it can be recognized that the person has moved from the position near the base 1910 to the position near the base station 1912, and then finally moves to a place near the base station 1914.

Since it is difficult to establish an identification of the place near the base station 1910 and so on, the place will be hereinafter identified by a name of a zone or area to which the base station belongs. That is, when it is recognized that the person 401 is at the place near the base station 1910, it will be indicated that the person 401 is in the room of the Design Department A 1920. According to the expression described above, it can be indicated that the person 401 moves from the Design Department A 1920 to the passage 1922, and then finally moves to the Accounting Department 1924. Here, the PHS terminal is regarded as the person 401.

In addition to the system described above, an entering-and-leaving management system using IC cards and IC card-readers can similarly measure the flow line. The system manages entering and leaving by means of an IC card-reader installed at an entrance of a room, whereby the IC card possessed by a person is read by the IC card-reader when the person enters or leaves the room. Since the system can determine who passes through which entrance at which time, a flow line can be obtained similar to that produced by the flow line measuring unit 206 using a PHS.

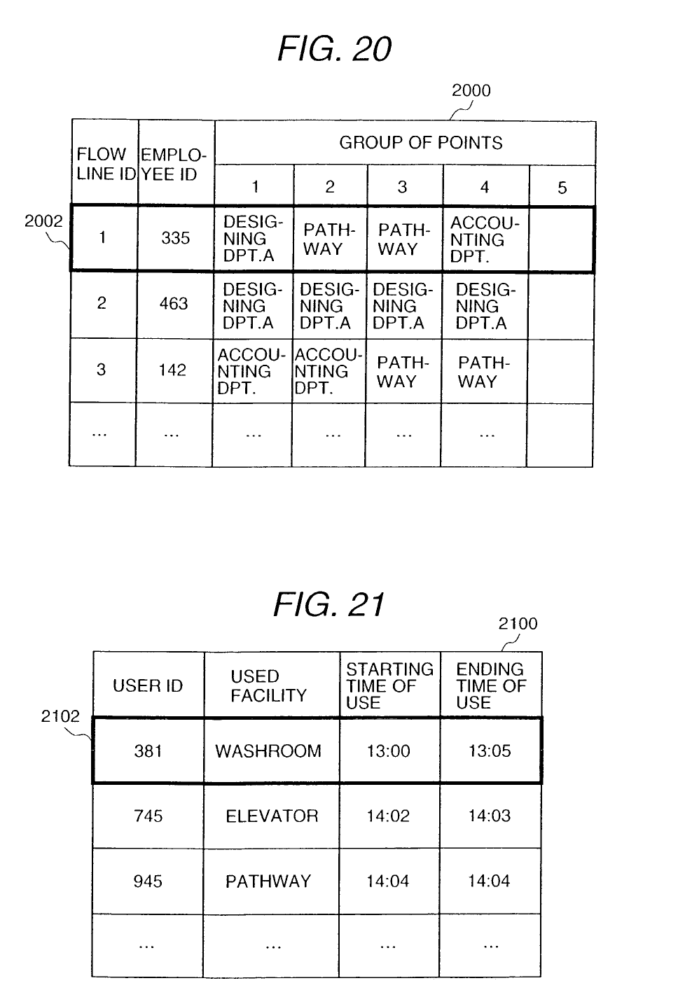

An example of a data structure, in a case where the flow line data that is measured using the system of FIG. 19 is handled using a computer, will be described with reference to FIG. 20. The table 2000 is a table for storing data of a plurality of flow lines 104 measured by the flow line-measuring means 102. Measured data for one flow line is stored in each row, that is, each record of the table. The record 2002 shows an example of stored flow line data for the flow line 402. The record includes a flow line ID in the form of a unique number for identifying measured flow line data, an employee ID in the form of a unique number identifying a person to be measured, and point train information consisting of a group of points on the flow line. Here, it is indicated that a person having an employee ID 335 moves along a path from the Designing Department A to the pathway, and then to the Accounting Department. However, it is not always necessary to store all of the information described above. Information not used for processes to be executed later need not be stored. On the contrary, information in connection with the flow line, such as the time of measuring the point train, other than the above information, may be stored, depending on necessity.

FIG. 7 is a flowchart showing an example of the flow of movement cost calculation processing in Step 354 of FIG. 3 in more detail. In this example, the total sum of the movement distances of the moving bodies within a determined time period is considered to be a movement cost. When the value is large, it is regarded that the uselessness of the movement is large because the time expended on useless actions of movement which produce no value. In Step 700, a variable COST storing a value of movement cost to be calculated thereafter is cleared to 0. In Step 702, the processes from Step 704 to Step 706 are repeated for all the flow lines measured within the determined time period. In Step 704, a length of flow line, that is, a flow line length L for a flow line to be processed is calculated. In Step 706, a value calculated by adding the flow line length L to be processed to the value of a variable COST is set to a new value of variable COST. By the processes described above, the total sum of the movement distances of the moving bodies within the determined time period can be calculated as a variable COST.

Although here the total sum of the movement distances is considered as the movement cost, the total sum of movement time may be considered as the movement cost. Further, when taking into consideration the fact that the cost per unit time, for example, payment per hour, is different depending on the particular moving body, the total sum of the cost per unit time of a moving body and moving time period of the moving body may be considered as the movement cost.

Further, when taking into consideration the fact that the cost per unit time or per unit distance is different depending on the moving means, the movement cost may be calculated by weighting the flow line.

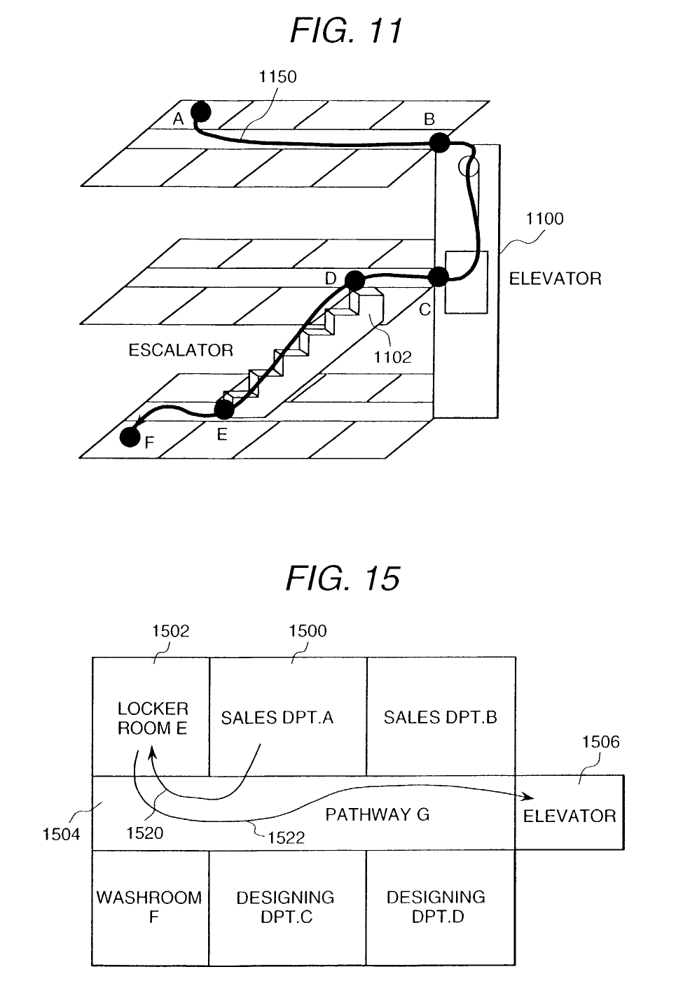

FIG. 11 shows a flow line 1150 that involves the use of an elevator 1100 and an escalator 1102. In the case of the flow line 1150, the section BC involves movement using the elevator 1100, and the section DE involves movement using the escalator 1102. The other sections involve movement by walking. Since the running cost and the maintenance cost are different depending on each of the moving means, it is considered that the cost necessary for movement is different depending on the moving means. Therefore, when taking into consideration the distance unit value of the cost when a moving means is used, the movement cost may be calculated by weighting the moving distance depending on the moving means, such as (the length of the section AB+the length of the section CD+the length of the section EF) X the distance unit cost of walking+the length of the section BC X the distance unit cost of the elevator+the length of the section DE X the distance unit cost of the escalator. Further, when taking into consideration the time unit value of the cost when a moving means is used, the movement cost may be calculated by weighting the moving time depending on the moving means as (a moving time period of the section AB+the moving time period of the section CD+the moving time period of the section EF) X the time unit cost of walking added to the moving time period of the section BC X the time unit cost of the elevator+the moving time period of the section DE X the time unit cost of the escalator.

Here, the movement cost may be calculated by weighting differently depending on the locations, even if the same moving means is used. For example, it is more difficult to walk at a place where many persons are coming and going even when movement is similarly performed by walking. Therefore, in such a case, the weighting should be increased. Similarly, the movement cost may be calculated by weighting specific information of the moving body, such as payment per hour, age, official position and type of job. Further, since it is more difficult to walk on a curved flow line than on a straight flow line, the movement cost may be calculated by weighting the curvature according to the degree of curvature of the flow line.

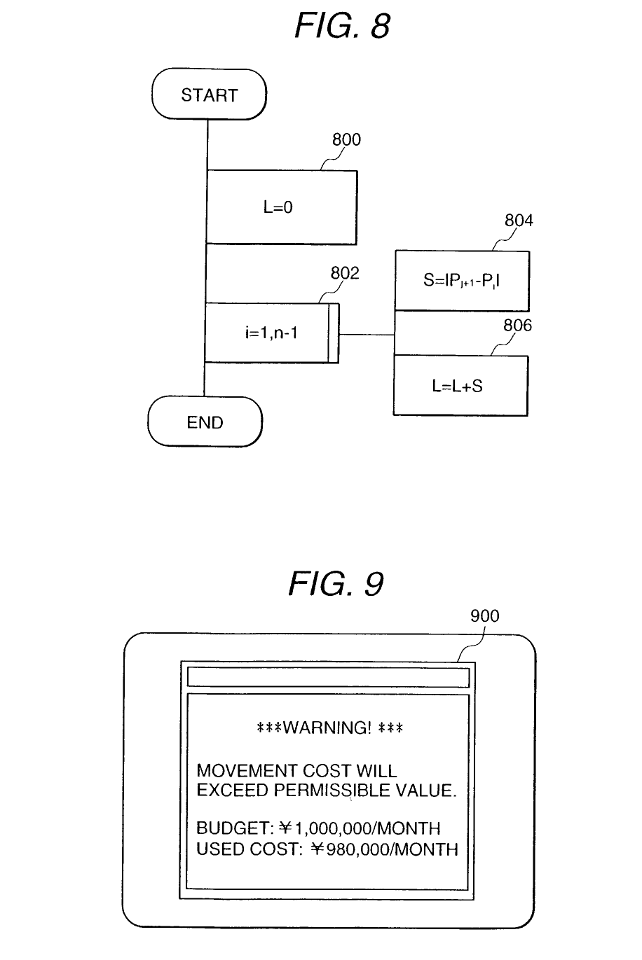

FIG. 8 is a flowchart showing an example of the flow line length calculation processing in Step 704 of FIG. 7. In this example, the flow line length is approximately calculated on the basis of the total sum of the lengths of sections consisting of the flow line data. In Step 800, a variable L representing a value of flow line length to be calculated thereafter is cleared to 0. In Step 802, the processes from Step 804 to Step 806 are repeated for a number of sections which make up the flow line data. Therein, letting the number of a train of points be n, the number of sections is n−1. In Step 804, the length of a section S for each of the sections to be processed is calculated. In Step 806, a value calculated by adding the section length S to be processed to the value of variable L is set to a new value of variable L. By the processes described above, the flow line length can be calculated as the variable L.

An example of a display produced by the output means 1I12 will be described with reference to FIG. 9. This view shows an example of a screen that is output when a movement cost exceeds a permissible value. On the screen, there are displayed character strings expressing a warning, a calculated movement cost and the permissible value of movement cost. The user of the present system can be informed by watching the warning that the movement cost now is in an unpredictable state, and he or she can take a measure toward correcting the problem, such as changing the layout. Although in the example the warning is displayed only using character strings, the warning may be visually displayed using an additional diagram or the like. Further, other display methods, such as sound, a window or a fragrance may be used.

By employing the structure described above, the cost expended on movement of the moving bodies can be quantitatively calculated, and a warning can be output to the user of the present system when the cost exceeds the permissible range. Therefore, the user of the present system can change the layout of the facility at an appropriate timing.

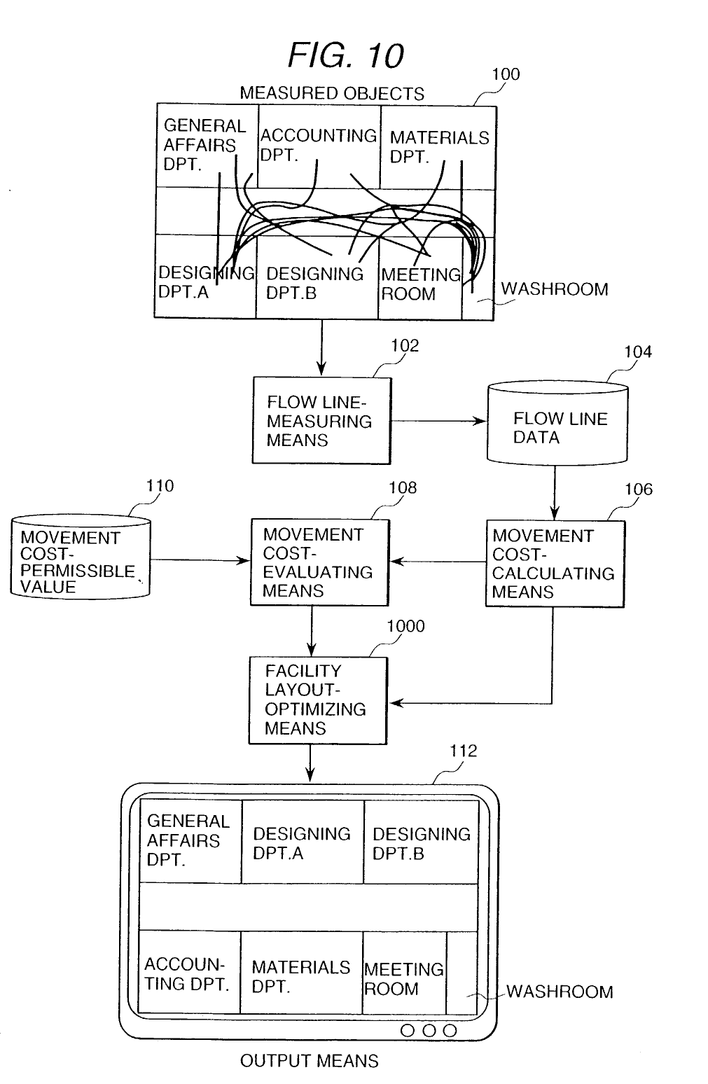

Although the above-described embodiment gives only a warning when the movement cost exceeds the permissible range, a modified plan for changing the layout may be proposed to the user of the present system. In such a case, a facility layout-optimizing means 1000, as shown in FIG. 10, is newly added to the functional structure shown in FIG. 1. The facility layout-optimizing means 1000 forms an optimized plan of the layout so as to minimize the movement cost and outputs the result when the movement cost exceeds the permissible range. In order to optimize the layout, a layout which minimizes the movement cost should be calculated by performing a simulation to predict-movement costs for all combinations of layouts. In performing a simulation of the movement cost, the movement cost should be calculated by calculating a relational degree between facilities from actually measured flow line data and then generating a simulated flow line between the facilities for a given layout with a probability corresponding to the relational degree.

An example of the relational degree between facilities expressing a depth of relation between facilities will be described below with reference to FIG. 25. The relational degree can be obtained by calculating the frequency of movement from one facility to the other facility from the measured flow line information, and then dividing the frequency of movement by a given time to obtain a frequency of movement per unit time. Assuming the given time is one minute, it can be understood from the element 2500 that the flow line the from General Affairs Department to the Accounting Department occurs with a frequency of 0.1 times per minute. When the value is large, the value indicates that the flow line between both facilities frequently occurs, and it means that the relation between both facilities is close.

By employing the structure described above, the user of the present system can immediately make a plan to change the layout, since a proposed modified plan of the layout is shown at the time the movement cost exceeds the permissible range, indicating that the layout should be reviewed.

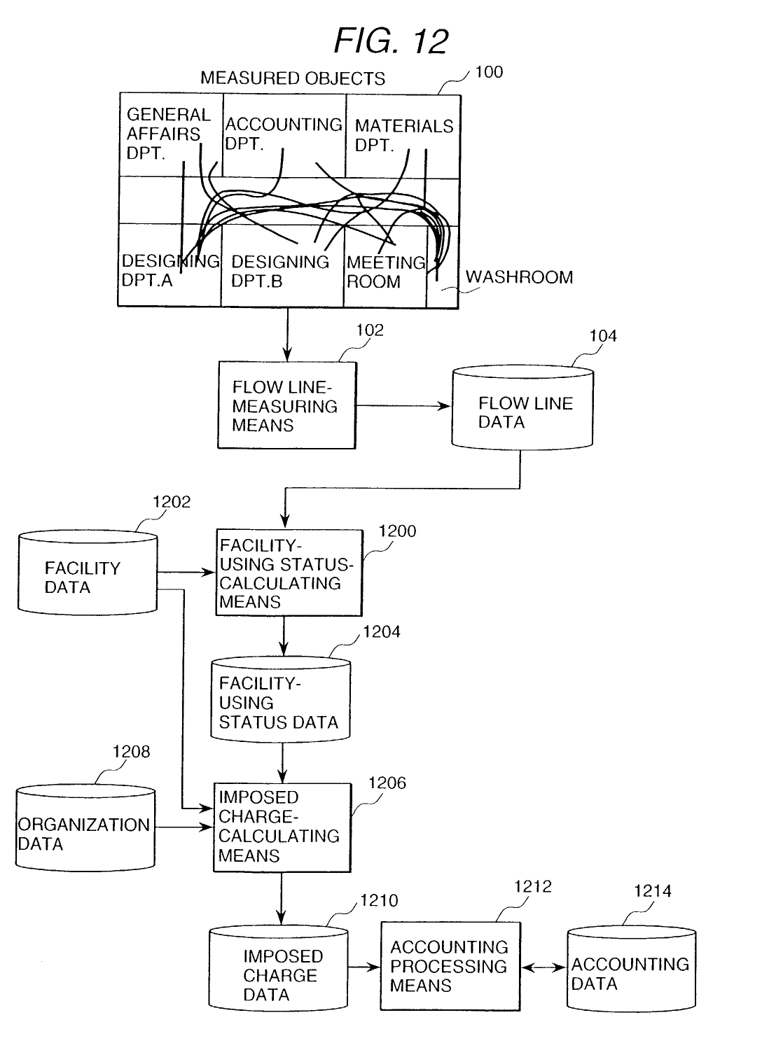

Another embodiment in accordance with the present invention will be described with reference to FIG. 12. This embodiment is a system which imposes a use charge in a facility based on the status of use of the facility calculated from flow line information. In the case of an office building, there are many common facilities, such as an elevator, a meeting room, a washroom and so on. In order to maintain these common facilities, the maintenance management cost, such as a maintenance charge, cleaning cost, electricity and heating cost, are required. In order to reduce unfairness as much as possible, the present invention provides a system for imposing these costs according to the status of use of such facilities. For example, every time an employee uses a common facility, such as an elevator, a use charge for the purpose of maintenance management of the facility is imposed on the department to which the employee belongs. The functional structure will be described with reference to FIG. 12. Since the measured object 100, the flow line-measuring means 102 and the flow line data 104 are the same as those described with reference to FIG. 1, an explanation thereof is omitted here. A facility-use status-calculating means 1200 calculates facility-use status data 1204 from the flow line data 104 and facility data 1202. The facility data 1202 is information specific to a facility, such as a place, maintenance management cost and so on for the facility requiring a cost for maintenance management. Further, the facility-use status data 1204 is information relating to use of the facility, such as the user, the period of use and so on.

Assuming that a person is regarded as using a facility when the person remains in the facility for a given time or longer, the use status of the facility can be calculated by checking the above information with the flow line data 104. An imposed charge-calculating means 1206 calculates imposed charge data 1210 which indicates the relationship between an amount of imposed money and a department to be charged from the calculated facility-use status data 1204, the facility data 1202 and organization data 1208 representing the relationship between the employee and the employee's department. An accounting processing means 1212 is totally in charge of the accounting processing of the company, and it undertakes procedure to impose the facility use charge on the department to which the user of the facility belongs, and then stores the result in accounting data 1214. Although in this embodiment the use charge is imposed on the department to which the user of the facility belongs, the use charge may be imposed directly on the user.

An example of a data structure, in a case where the facility-use status data 1204 is handled using a computer, will be described with reference to FIG. 21. The table 2100 is a table for storing plural kinds of facility-use status data 1204 calculated by the facility-use status-calculating means 1200. Calculated data for one facility use status is stored in each row, that is, each record of the table. For example, the record 2102 includes an employee ID identifying a user of a facility, the facility, and the starting time of use and ending time of use. However, it is not always necessary to store all the information described above. On the contrary, information in connection with the use status of the facility, other than the above information, may be stored, depending on necessity.

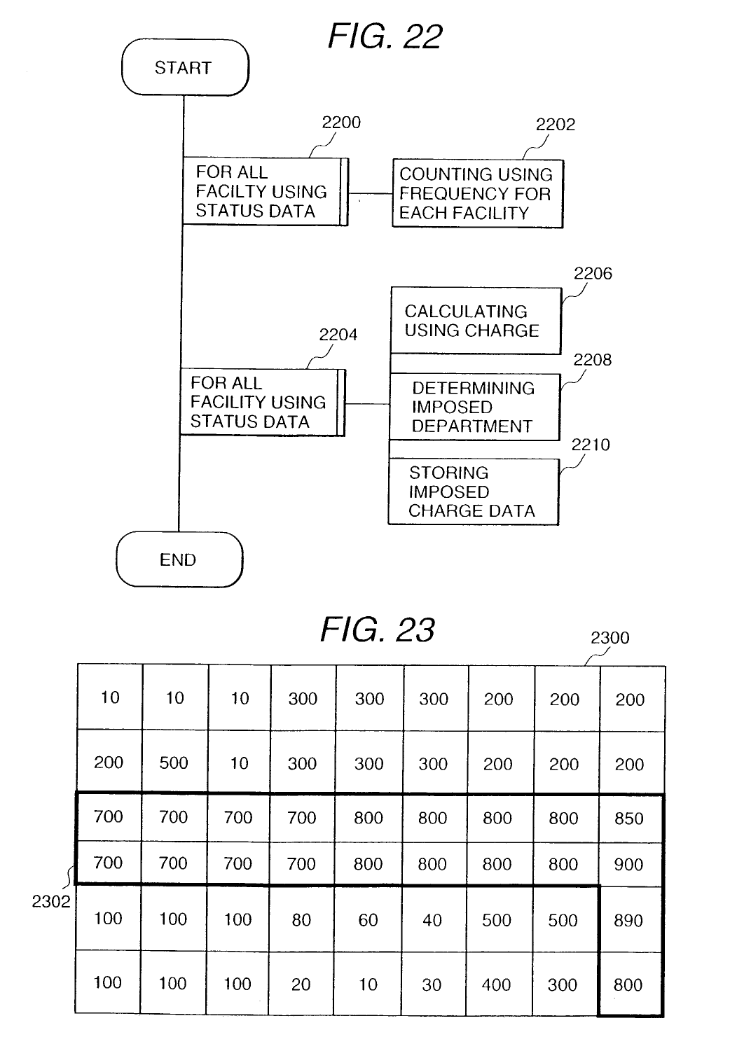

FIG. 22 is a flowchart showing the flow of processing of the imposed charge-calculating means 1206. The processing from Step 2200 to Step 2202 involves processing for calculating the frequency of use for each of the facilities which is used for calculating an imposed charge later. Step 2200 calls for repeating the processing of Step 2202 for all of the facility-use status data within a given time period. In Step 2202, a frequency of use for each of the facilities is calculated based on the processed facility-use status data. Successively, the processing from Step 2204 to Step 2210 involves processing for actually determining a use charge for the facilities and a department on which the use charge of the facilities will be imposed. Step 2204 calls for repeating the processing from Step 2206 to Step 2210 for all of the facility-use status data within the given time period.

In Step 2206, a use charge for the facilities in regard to the facility-use status data to be processed is calculated. As the use charge of the facilities, it is possible to use a value calculated by dividing a cost required for maintaining the facilities during a given time period by the frequency of use of the facilities. For example, in a facility requiring a maintenance management cost of one million yen per month, the use charge per each use becomes 100 yen when the facility is used 10,000 times during one month period. In Step 2208, a department on which the use charge calculated in Step 2206 is to be imposed is determined. In order to make the determination, a department to which the use of the facility belongs should be searched from the organization data 1208. In Step 2210, the information of the calculated use charge and the identified department is stored as the imposed charge data 1210.

By employing the structure described above, the present invention can be applied to a building not having a POS, because the cost for use of the facility can be imposed on the department to which the user belongs.

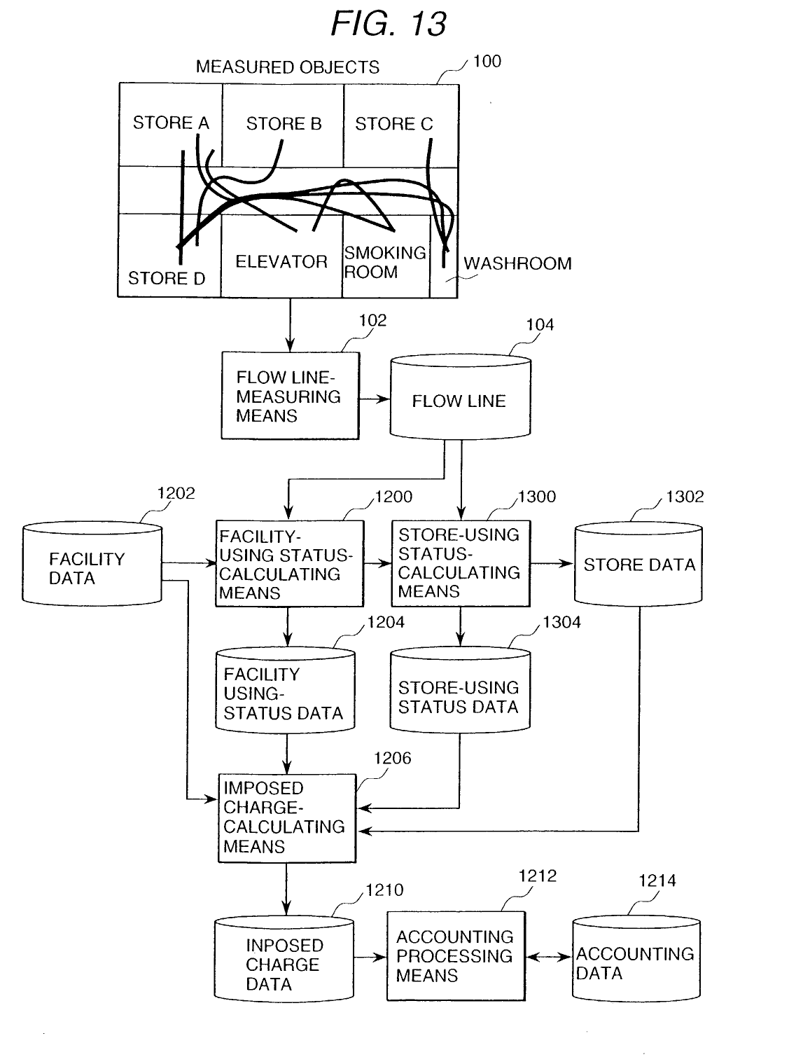

The present invention also can be applied to a shopping building occupied by a plurality of retail stores, as well as the office building used in the example of FIG. 12. FIG. 13 shows an example of such an embodiment. Although in the case of the office building the use charge of the facility is imposed on the department to which the user of the facility belongs, in the case of a shopping building, it is considered more appropriate rational that the use charge of the facility is imposed on a store at which a shopper drops in for shopping. In this case, since the shopper often drops in at a plurality of stores, the use charge of the facility is imposed on a plurality of stores.

The functional structure of this embodiment will be described with reference to FIG. 13. Since the components are the same as those the embodiment of FIG. 12, except for use of a store-use status-calculating means 1300, store data 1302 and store-use status data 1304, an explanation of the same components will be omitted here. The store-use status-calculating means 1300 calculates the store-use status data 1304 from the flow line data 104 and store data 1302. The store data is information specific to a store, such as the location of the store etc. Further, the store-use status data 1304 is information on the use of a store, such as a shopper visiting the store, the time the shopper remains in the store and so on. Assuming that a person is regarded as using a store when the person remains inside the store for a given time or longer, the use status of the store can be calculated by checking the above information with the flow line data 104. An imposed charge-calculating means 1206 calculates imposed charge data 1210 representing the relationship between an amount of imposed money and a store to be charged from the calculated store-use status data 1304, the facility-use status data 1204, the store data 1302 and the facility data 1202. Although in this embodiment the use charge is imposed on the store which the shopper uses, the use charge may be imposed directly on the user.

By employing the structure described above, the charge can be imposed even in the case where a charge is imposed on a plurality of stores, because the cost for use of the facility can be imposed on the store at which the user drops in.

Although the above-described forms of imposing a use charge are different between the embodiment of FIG. 12 and the embodiment of FIG. 13, a system mixing both forms may be considered. For example, in the case of a shopping building, the scheme used by the embodiment of FIG. 13 is applied by imposing a charge caused by the shopper, and the scheme used in the embodiment of FIG. 12 is applied by imposing of a charge caused by the employee of the store. By employing the structure described above, the imposing of a charge for use of a facility which meets the actual situation can be achieved.

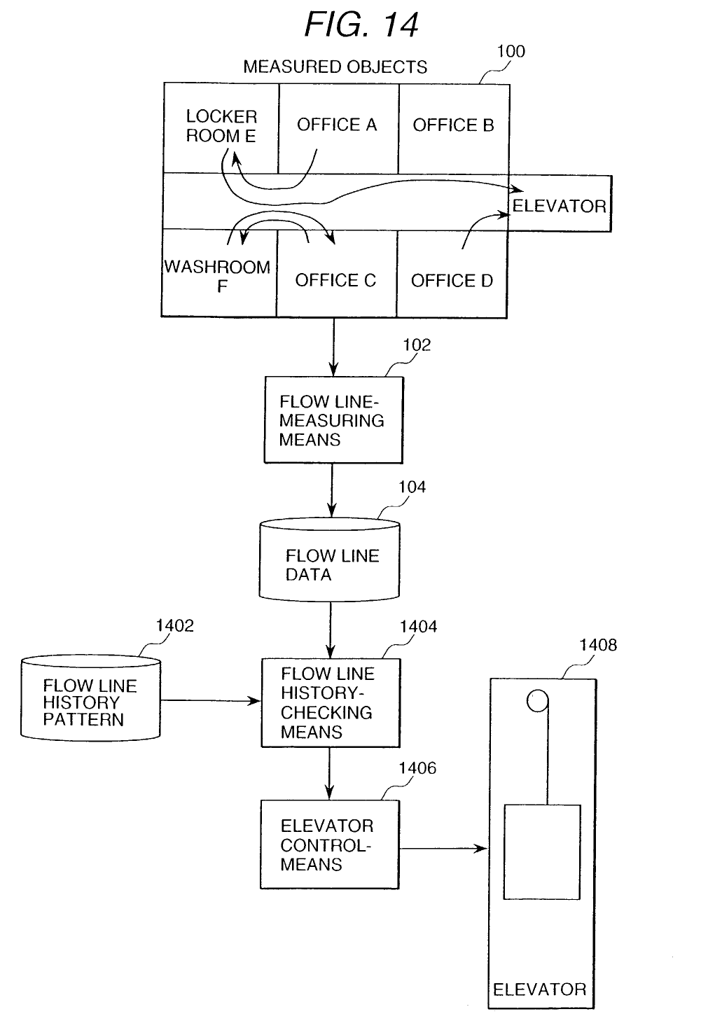

Another embodiment in accordance with the present invention will be described with reference to FIG. 14. This embodiment is directed to a system for controlling a facility ancillary to a building, such as an elevator, an automatic door, and an air conditioner, based on flow line history information. It may often be observed that a person in charge of sales drops in at a locker room before going out.

In such a case, when a flow line 1522 moving from a locker room E 1502 to a pathway G 1504 is measured after a flow line 1520 moving from Sales Department A 1500 to the locker room E 1502, as shown in FIG. 15, an elevator 1506 is automatically called in anticipation of the face that the elevator 1506 will be used next with a high probability.

The functional structure will be described with reference to FIG. 14. This example involves the operation of automatically calling for an elevator when a specific flow line history is measured. The flow line-measuring means 102 previously described detects a moving body in a monitored object 100 and measures the flow line to accumulate the result as flow line data 104. A flow line history pattern 1402 indicates a condition for calling the elevator. The flow line history pattern may be manually set by a person, or it may be automatically produced using a computer by analyzing the tendency from past flow line data 104. A flow line history-checking means 1404 judges whether or not the measured flow line data 104 meets the flow line history pattern 1402. If it is judged that the measured flow line data 104 meets the flow line history pattern 1402, the flow line history-checking means 1404 outputs a control signal for calling the elevator 1408 using an elevator-control means 1406.

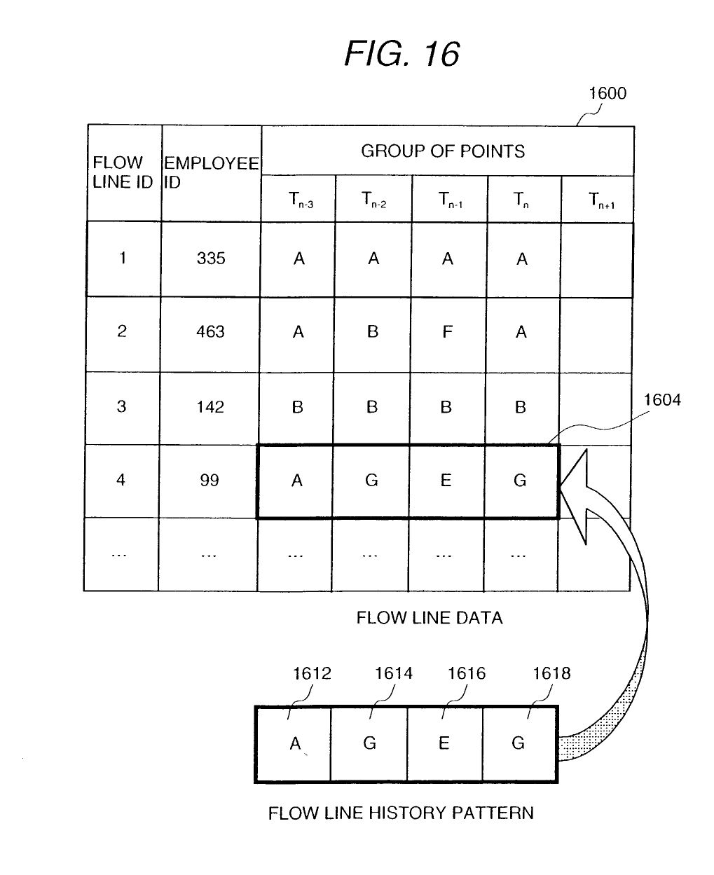

A procedure for checking the flow line history using the flow line history-checking means 1404 will be described with reference to FIG. 16. The table 1600 is a table for storing plural kinds of flow line data measured by the flow line-measuring means 102, and it has a similar format to that shown in FIG. 20. A flow line history pattern 1610 indicates that a searched object follows a flow line of movement in the order of a position A 1612, a position G 1614, a position E 1616 and a position 1618. In the table 1600, the flow line data meeting the flow line history pattern 1602 is a flow line record 1604. Therefore, this flow line data is the result checked by the flow line history-checking means 1404.

Although each element of the flow line history pattern 1610 and the point sequence of the flow line are checked in one-to-one correspondence here, checking by normalized expression commonly used in a character sequence check using a computer may be used in order to achieve fuzziness. For example, in a case where a person moves in order of AGEG, the flow line measured by the speed of movement may sometimes become a form which shows the person staying at the same position plural times, such as AAGEG, AGGEG or the like. However, what is important here is only the order relation of AGEG, and the number of times a person stays at the same position does not need to be considered. In the present case, the table should be searched by representing the flow line pattern 1610 as “A+B+E+G+” by the normalized expression. There, the character “+” indicates the once-or-more repetition of a character just before the character “+”. That is, the pattern meets a flow line of once-or-more repetition of A, once-or-more repetition of B, once-or-more repetition of C and once-or-more repetition of D.

Although calling of the elevator is automated in this embodiment, changing the operating mode of the elevator may be considered. For example, in the case of a person moving to the elevator from a clinic, the operating mode may be changed to a wheelchair mode in which the time period for keeping the door open of the elevator open is extended, because it possible that the person can not move normally. Further, in a case where the speed of movement of a calculated flow line is slow, the operating mode may be changed to the wheelchair mode due to the possibility that the person can not move normally.

By employing the structure described above, the calling condition of the elevator can be freely set based on the flow line information of a person, and the present embodiment can be applied to a building other than an apartment house in which action patterns of persons are limited.

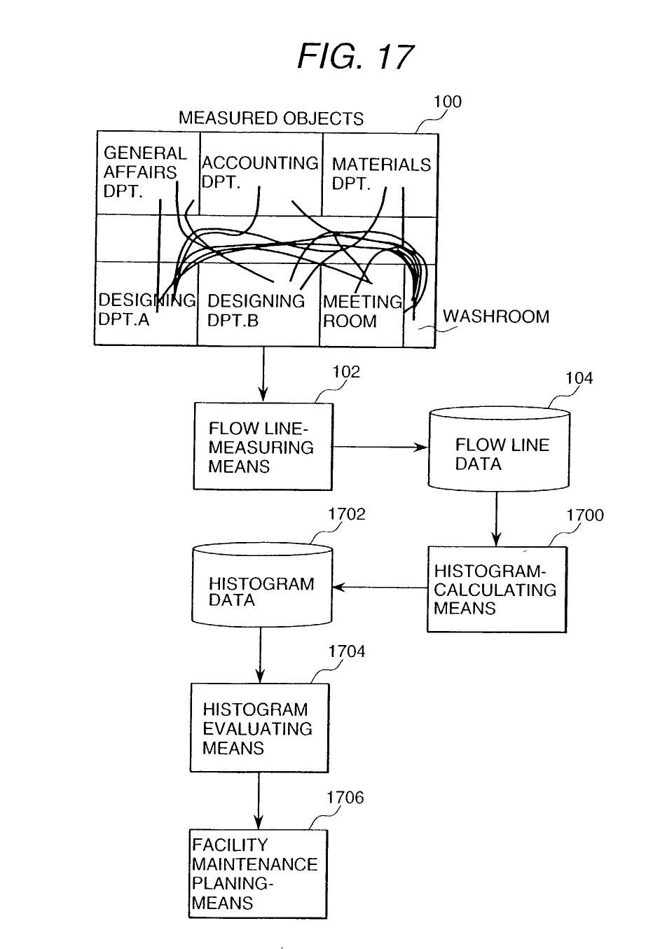

Another embodiment in accordance with the present invention will be described with reference to FIG. 17. This embodiment is directed to a system in which a place having a particularly high frequency of use among spatial facilities, such as a room, a pathway and the like is determined based on flow line information, and maintenance management is concentrated on the determined place. It is considered that a place having many persons passing through, for example, a pathway in an office building, becomes more dirty compared to other places in the building. Therefore, by determining that cleaning such a place should take first preference, cleaning work can be efficiently performed with less cleaning cost.

The functional structure will be described with reference to FIG. 17. The measured object 100, the flow line-measuring means 102 and the flow line data 104 are the same as those described with reference to FIG. 1, and so an explanation thereof will be omitted here. A histogram-calculating means 1700 calculates histogram data 1702 representing a spatial frequency of use of a facility. Using the frequency of use obtained from the calculated histogram data 1702, a histogram-evaluating means 1704 forms a maintenance plan corresponding to the frequency of use and outputs the result to a facility maintenance planning means 1706 for actually integrating the whole maintenance plan. A concrete example of such a maintenance plan involves the assuring of a request for cleaning a place having a frequency of use larger than a given value. Further, as for a place having a frequency of use smaller than a given value, since this means that persons hardly use the facility, the facility may be eliminated or the layout may be changed.

An example of the outline of the processing of the histogram-calculating means 1700 will be described with reference to FIG. 18. A spatial facility, such as a hallway, is divided into a plurality of small zones, and a value of frequency having number of flow lines passing through each zone is given to the zone. For example, in the case of a flow line 1800, the value of frequency in each zone, from a small zone 1810 to a small zone 1816 through which the flow line passes, is increased by 1 (one) for each of the zones. By applying this processing to all of flow lines occurring during a given time period, the number of flow lines passing through each of the small zones can be obtained.

Further, information relating to movement between the small zones may be calculated along with calculation of the frequency of flow lines passing through the small zone. The information relating to movement between the small zones indicates a probability of movement from a small zone to an adjacent small zone or a difference of persons coming in and going out between small zones adjacent to each other. By showing such information to a person, the person can easily grasp the flow of flow lines.

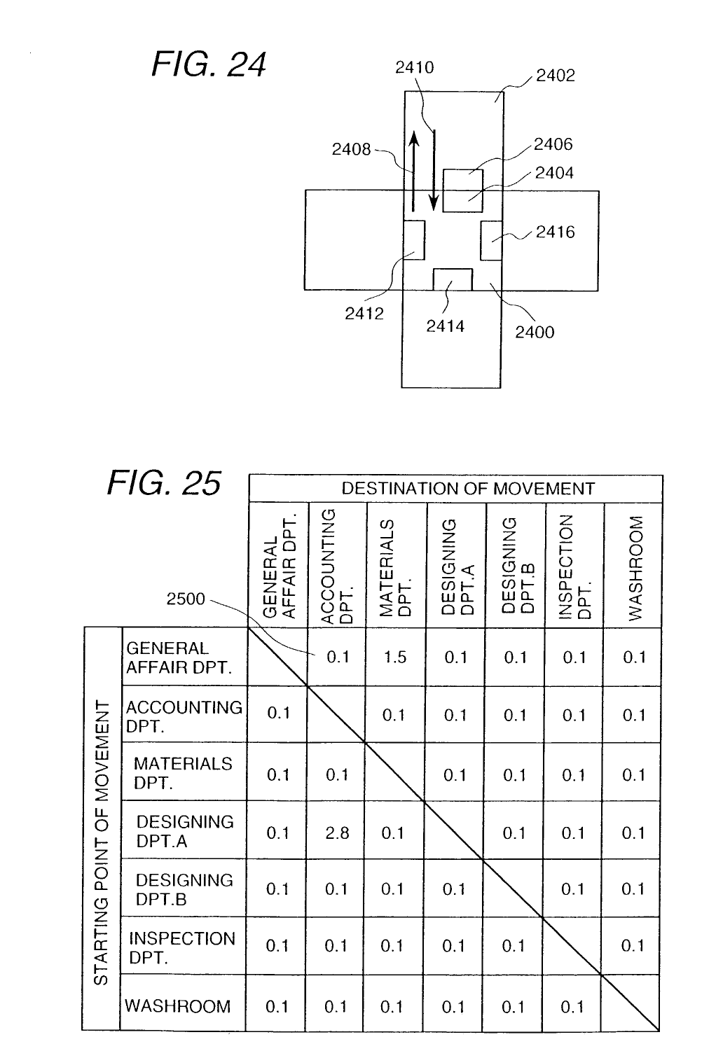

The information relating to movement will be explained with reference to FIG. 24. A movement frequency holding zone 2404 and a movement frequency holding zone 2406 for holding information relating to movement between the small zone 2400 and the small zone 2402 are provided between the small zone 2400 and the small zone 2402. The movement frequency holding zone 2404 holds a value corresponding to the frequency of movement from the small zone 2400 to the small zone 2402. On the other hand, the movement frequency holding zone 2406 holds a value corresponding to the frequency of movement from the small zone 2402 to the small zone 2400. For example, when a flow line 2408 occurs, the value of the movement frequency holding zone 2404 is increased by 1 (one) since movement from the small zone 2400 to the small zone 2402 has occurred. When a flow line 2410 occurs, the value of the movement frequency holding zone 2406 is increased by 1 (one) since movement from the small zone 2402 to the small zone 2400 has occurred. Although the relation between the small zone 2400 and the small zone 2402 has been described above, movement frequency holding zones are similarly provided between the other zones.

By executing such processing of the movement frequency for the flow lines occurring during a given time period, a probability of movement from one zone to another zone can be determined. For example, the probability of movement from the small zone 2400 to the small zone 2402 can be calculated by “(the movement frequency from the small zone 2400 to the small zone 2402)/(the total movement frequency from the small zone 2400 to the all adjacent small zones)”. There, the frequency of movement from the small zone 2400 to the small zone 2402 is a value held by the movement frequency holding zone 2404. The total frequency of movement from the small zone 2400 to the all adjacent small zones is the total sum of the values held by the movement frequency holding zone 2404, the movement frequency holding zone 2412, the movement frequency holding zone 2414 and the movement frequency holding zone 2416. Further, the difference in the number of persons coming in and going out from one zone to another zone can be determined. For example, by subtracting a value held by the movement frequency holding zone 2406 from a value held by the movement frequency holding zone 2404, the difference in the number of persons coming in and going out between the both small zones is obtained. When the value is positive, it means that the number of persons going out from the small zone 2400 to the small zone 2402 is larger than number of persons coming in from the small zone 2402 to the small zone 2400. When the value is negative, it means that number of persons going out from the small zone 2400 to the small zone 2402 is smaller. When the value is 0 (zero), it means that there is no difference between the number of persons going out and coming in.

An example of the outline of the processing of the histogram-evaluating means 1704 will be described with reference to FIG. 23. Histogram data 2300 is in the form of a table holding the number of flow lines passing through a facility, that is, a passing-through frequency value, and the number in each small zone indicates the passing-through frequency. When a frequency value of a small zone becomes larger than a given allowable value, the histogram-evaluating means 1704 judges that cleaning is required. Here, when the allowable value is assumed to be 700, a group of the small zones 2302 are designated as objects to be cleaned. The histogram-evaluating means 1704 notifies a facility maintenance-planning means 1706 of the zones which are objects to be cleaned. When cleaning is completed, the histogram-evaluating means 1704 clears the frequency values to 0 to prepare for cleaning next time. Further, it is possible that the values of the histogram data 2300 are shown to the user to entrust the judgment to the user. In this case, in order to make the histogram data 2300 easily understandable, the visualization technology used in visualization of scientific and technical calculation results should be used. For example, in a case of visualizing scalar quantities, such as the passing-through frequencies of the small zones in the histogram data 2300, the scalar quantities should be displayed by a contour map in which small zones of an equal passing-through frequency are connected by a line. In a case of visualizing vector quantities, such as the movement frequencies between the small zones in the histogram data 2300, the vector quantities should be displayed by a vector map in which the vector is displayed by an arrow. In this case, the length, the thickness, the color or the brightness of the vector may be varied according to the magnitude of the movement frequency.

By employing the structure described above, effective maintenance management can be performed because a place used by many persons can be determined and maintenance management can be concentrated on that place.

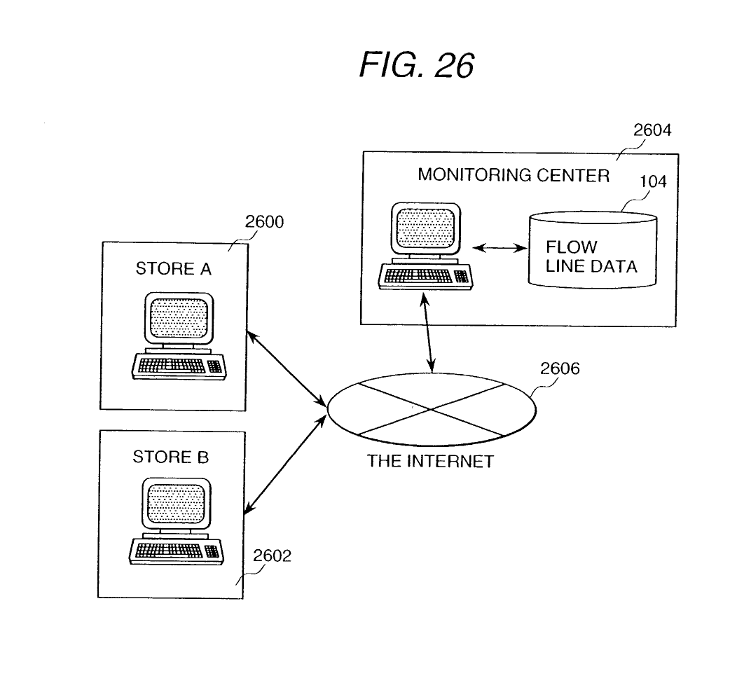

A form of business using the movement cost monitoring system of FIG. 1 will be described below. Therein, the embodiment is directed a monitoring service business in which a monitoring center interactively monitors flow line statuses in a plurality of stores and recommends to improve service measure to a store when the movement cost to the store is large. FIG. 26 shows a business form in which the movement costs occurring at a store A (2600) and a store B (2602) are remotely monitored at a monitoring center 2604. The monitoring center 2604 is connected to the store A (2600) and the store B (2602) by the Internet 2606 to make mutual data exchange possible.

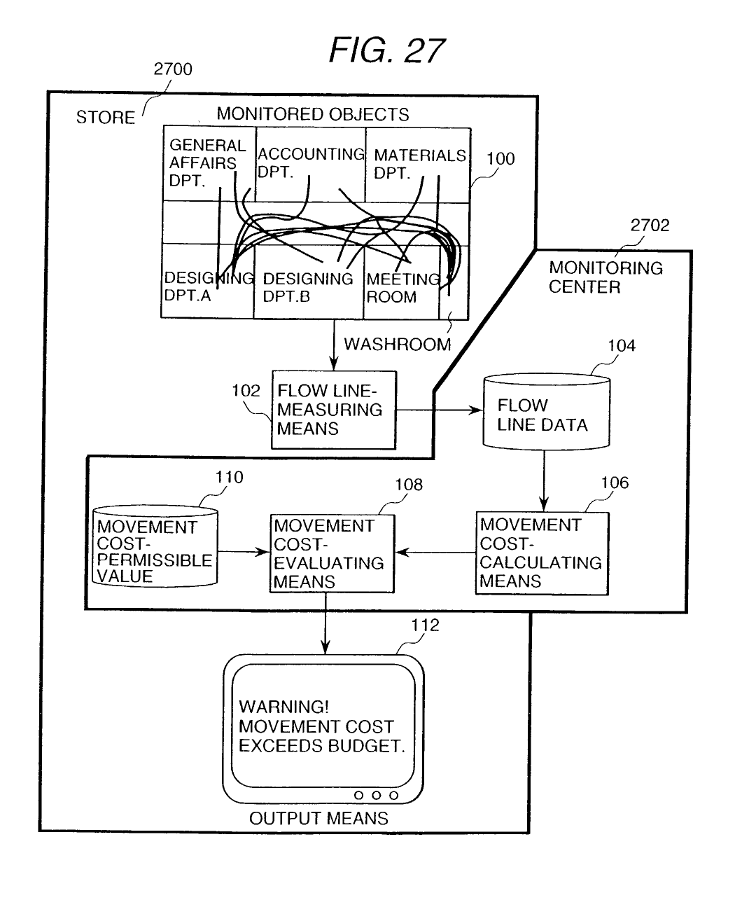

FIG. 27 shows the detailed functional structure for applying the movement cost monitoring system in accordance with the present invention to the business form described above. Although the movement cost monitoring system is functionally similar to the system shown in FIG. 1, the difference is that the functions are distributed and allocated to the stores 2600, 2602 and the monitoring center 2604. A domain 2700 represents functions which should be allocated to the store to be monitored. It can be understood from the figure that a flow line-measuring means 102 and an output means 112 are allocated to the store. On the other hand, a domain 2702 represents functions which should be allocated to the monitoring center 2606 for monitoring the stores to be monitored. It can be seen from the figure that a movement cost-calculating means 106, a movement cost-evaluating means 108, flow line data 104 and a movement cost-permissible value 110 are allocated to the monitoring center 2606.

The flow of the processing in the business for is the same as the processing shown by the flowcharts of FIGS. 3(a) and 3(b), and it can be divided into two kinds of processing, that is, processing for collecting flow line data and processing for evaluating the flow line data. FIG. 3(a) is flowchart showing the processing for collecting the flow line data. This is a process for obtaining the flow line of a moving body in each of the stores to be monitored. In Step 300, the process of Step 302 is repeated with a given frequency. In Step 302, the position of the moving body in each of the stores is measured using the flow line-measuring means 102 installed in each of the stores. By the processes of Step 300 and Step 302, the flow line of the moving body can be obtained. In the monitoring center 2604, the result is accumulated as the flow line data 104.

Next, the process of evaluating the flow line data, as shown in FIG. 3(b), will be described. This is a process for evaluating the flow line data 104 obtained by the measurement. In Step 350, a monitoring person at the monitoring center sets a movement cost-permissible value 110. In Step 352, the processes of Steps 354 to 358 are repeated with a given frequency. In Step 354, a movement cost expended on movement of the moving body is calculated using the flow line data for the given time period by the movement cost-calculating means 106 installed in the monitoring center 2604. In Step 356, it is judged whether or not the calculated movement cost is within the range of the permissible value using the movement cost-evaluating means 108 installed in the monitoring center 2604. In Step 358, when it is judged in Step 356 that the movement cost of a store exceeds the permissible value, a warning is output to a manager of the store to be monitored using the output means 112 installed in the shop.

Since the data necessary for monitoring can be exchanged through the Internet by employing the business form described above, the monitored object and the monitoring center can be separated from each other, and remote monitoring can be realized. Further, since the monitoring center can exchange data with a plurality of monitored objects, a plurality of monitored objects can be monitored by a single monitoring center, and, accordingly, an efficient monitoring business can be realized.

According to the present invention, by limiting the objects to be monitored to specific persons, such as employees or residents having strong connection to a facility to be monitored, a condition of appropriateness of the layout can be quantitatively determined in the form of the total flow line length of persons, that is, the movement cost, and a warning can be output to the user of the present system when the movement cost exceeds the permissible value. Therefore, the user of the present system can change the layout of the facility at an appropriate time.

Further, according to the present invention, since the cost for using a facility can be imposed on a department to which a person using the facility belongs based on flow line information of the person, the present invention can be applied to a building not having an OPS.

Further, according to the present invention, since the condition of calling an elevator can be freely set based on the flow line information of persons, there is an effect that the present invention can be applied to other buildings, as well as an apartment house, where action patterns of persons are limited.

Furthermore, since a place used by many persons can be determined and maintenance management can be concentrated on the determined place, the maintenance management can be effectively performed.

What is claimed is:

1. A facility maintenance assisting system, which comprises:
a flow line-measuring means for detecting a moving body in a monitored object, and then measuring a flow line of the detected object;
a histogram-calculating means for dividing a facility into small zones from said flow line data, and then calculating histogram data expressing a using frequency for each of said small zones;
a histogram-evaluating means for forming a maintenance plan corresponding to said using frequency obtained from said calculated histogram using said using frequency; and
a facility maintenance planning means for integrating the whole maintenance plan based on said maintenance plans.

2. A facility maintenance assisting system according to claim 1, which comprises a facility maintenance planning means for actually integrating the whole maintenance plan.

3. A facility maintenance assisting system according to any one of claim 1, wherein said histogram-calculating means calculates a movement frequency between said small zones.

4. A facility maintenance assisting system according to any one of claim 3, wherein said histogram-calculating means calculates a movement frequency between said small zones.
